(19) United States
(12) Patent Application Publication
(10) Pub. No.: US 2012/0221971 A1
(43) Pub. Date: Aug. 30, 2012

(54) USER INTERFACE FOR PRESENTING GRAPHICAL ELEMENTS

(75) Inventors: Nicholas Trotta, San Francisco, CA (US); George Alfred Arriola, San Francisco, CA (US); Vince Nakayama, Los Altos, CA (US)

(73) Assignees: Sony Network Entertainment Inc., Los Angeles, CA (US); Sony Corporation, Tokyo (JP)

(21) Appl. No.: 13/036,678

(22) Filed: Feb. 28, 2011

(51) Int. Cl. G06F 3/048

(52) U.S. Cl. 715/803

(57) ABSTRACT

Methods and apparatus are provided for presenting a plurality of media titles. In one embodiment, a method includes detecting a user input associated with a displayed user interface, and determining one or more media titles for presentation in response to the user input, wherein media titles are selected based on ratings generated for each media title relative to one or more attributes associated with the user. The method may further include displaying a first a graphical element based on a selected media title, wherein the first graphical element is assigned a focus state and associated with a position of a spiral formation, and displaying at least one additional graphical element based on one or more selected media titles, wherein the at least one additional graphical element is assigned a focus state and associated with a position of the spiral formation. The method may further include adjusting user interface display.

### CROSS REFERENCE TO RELATED APPLICATION

This application is related to commonly-assigned and concurrently filed U.S. patent application Ser. No. ______, entitled “Method and Apparatus for Presenting Elements of a User Interface”, the disclosure of which is hereby fully incorporated by reference.

### FIELD

The present patent disclosure relates generally to presentation of user interface elements, and more particularly to methods and apparatus for presenting graphical elements.

### BACKGROUND

Typical methods of providing a device interface are usually directed to device operation for playback of a single media file or source. Some conventional devices provide graphical menus for selection of particular media. However, these methods and devices generally require a particular input device for user selection.

With the development of network based services, many providers of media content allow for purchase and/or renting of media. Many users desire an interface for viewing and selecting media. Conventional approaches generally provide interfaces similar to network browser applications for selecting media. However, the conventional user interfaces and devices may not be suitable for presenting a plurality of files. In many instances, users desire the ability to browse a plurality of media files for rent and/or purchase on a display device using device input controls. One drawback of typical systems may be the ability to view or even navigate to a desired media title, especially when the number of titles that may be accessed is immense. Thus, there is a desire for a user interface that allows for selection and presentation of a large amount of relevant media that may be accessed using device controls. Further, there exists a need to allow for a more efficient and visually pleasing presentation of content to a user.

### BRIEF SUMMARY OF THE EMBODIMENTS

Disclosed and claimed herein are methods and apparatus for displaying a user interface to present a plurality of media titles. In one embodiment, the method includes detecting a user input associated with a displayed user interface, and determining, by a device, one or more media titles for presentation in response to the user input, wherein media titles are selected based on ratings generated for each media title relative to one or more attributes associated with the user. The method further includes displaying a first a graphical element based on a selected media title, wherein the first graphical element is assigned a focus state and associated with a position of a spiral formation, and displaying at least one additional graphical element based on one or more selected media titles, wherein the at least one additional graphical element is assigned a focus state and associated with a position of the spiral formation. The method further includes adjusting the display of the user interface, wherein a display position of each displayed graphical element is advanced relative to a previous display position of the spiral formation.

Other aspects, features, and techniques of the disclosure will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a user interface according to one embodiment;

FIG. 2 depicts a simplified block diagram of a device according to one embodiment;

FIG. 3 depicts a process for displaying a user interface according to one embodiment;

FIG. 4 depicts a graphical representation of a spiral formation according to one or more embodiments;

FIG. 5 depicts a graphical representation of presenting graphical elements according to another embodiment;

FIG. 6 depicts a graphical representation of adjusting a focus state according to one embodiment;

FIG. 7 depicts a graphical representation of a user interface according to another embodiment; and

FIGS. 8A-8B depict graphical representations of user interface focus states according to one or more embodiments.

### DETAILED DESCRIPTION OF THE EXEMPLARY EMBODIMENTS

### Overview and Terminology

One aspect of the present disclosure relates to displaying a user interface to present a plurality of media titles. Accordingly, a device and methods are provided for display of a plurality of graphical display elements. In one embodiment, graphical elements associated with media titles may be presented based on a structural formation. For example, elements may be displayed as moving along a path or formation, such as a spiral. In addition, a process is provided for selecting media titles for display. One advantage of the invention may be the ability to determine or select one or more media titles based on one or more user attributes including user viewing history, media library of the user, user selections of a user interface and one or more attributes associated with a user. In one embodiment, one or more media titles may be determined for presentation by rating the media titles based on attributes associated with the media titles and one or more attributes associated with a user. Presentation of media titles may further be based on a determination of the most relevant and/or important media titles to a user. In that fashion, presentation of one or more media files may be provided to user based on an arrangement of media titles and a determination of one or more relevant media titles.

Display of the graphical elements may include displaying first a graphical element with a first position of a spiral formation, and one or more additional graphical elements along the spiral formation following presentation of the first graphical element. In one embodiment, the graphical elements may be presented as an animation, wherein the display of the graphical elements may be characterized as providing an appearance of a graphical element as floating and/or suspended within at least a portion of a user interface. During display of the graphical elements, a focus state relating to one or more of shape, size and transparency may be graduated as the graphical element is advanced along the spiral formation.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or a similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner in one or more embodiments without limitation.

In accordance with the practices of persons skilled in the art of computer programming, the disclosure is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the disclosure are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### EXEMPLARY EMBODIMENTS

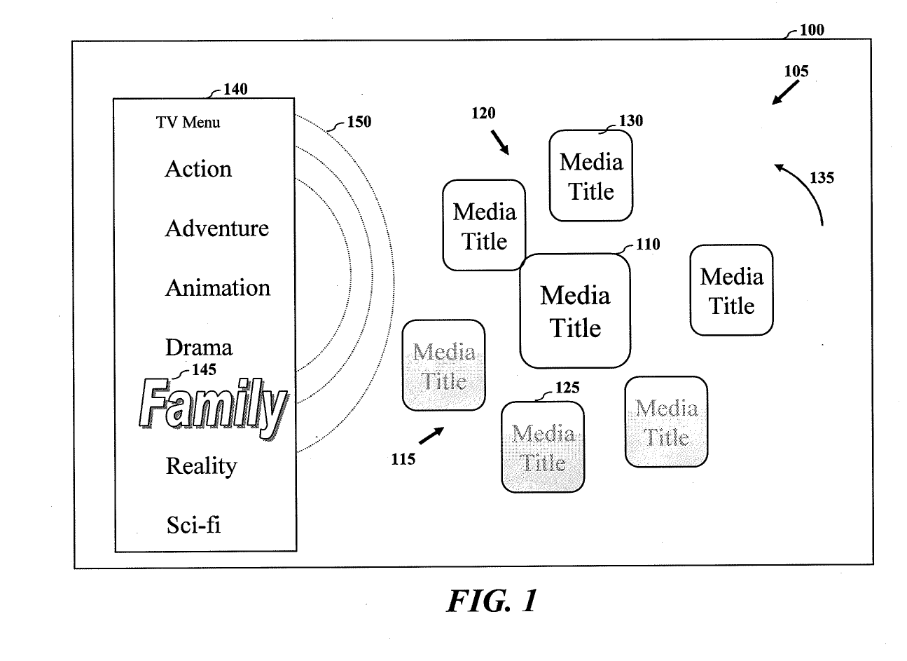

Referring now to the figures, FIG. 1 depicts a graphical representation of a user interface according to one embodiment. As depicted, user interface 100 includes a plurality of graphical elements shown as 105. In particular, user interface 100 may display one or more graphical display elements to present a plurality of media titles in a particular formation. Graphical elements 105 may relate to a subset of media titles which may be presented to a user. It should also be appreciated that additional, or fewer, media titles may be displayed by the user interface. Media title 110, for example, may relate to a graphical image, video, animation, and/or text associated with a media file. By way of further example, when media presented by user interface 100 relates to movie titles, media titles may be displayed as cover art for a particular movie title. Media titles displayed by user interface 100 may relate to one or more of movie titles, video content, broadcast media (e.g., television series), audio files, etc. As such, when media presented by user interface 100 relates to an audio title, media titles may be displayed as cover art, lyrical text, and/or video data associated with the title. It should also be appreciated that media titles presented by user interface 100 may not be limited to a single type of media title.

User interface 100 may be configured to display graphical elements in a spiral arrangement. The display of graphical elements in an arrangement may be based on a user selection of user interface 100. The spiral arrangement of FIG. 1 includes first graphical display element 110 displayed in a central position within other spirally arranged graphical display elements. The spiral arrangement may include a plurality of graphical display elements, shown as 115, each of which having a focus state, and a second group of graphical display elements, shown by 120, with a second focus state. By way of example, graphical display element 125 associated with first group 115, may include a normal state, wherein focus is off. Media title 130 associated with second group 120, however, may be displayed with a focused state wherein focus is on. User interface 100 may provide a rotating display of graphical display elements wherein elements of groups 115 and 120 may rotate as shown by direction 135. User interface 100 may be presented as an animation of graphical display elements, wherein elements related to the first display element 110 appear to be actively added while being viewed. In certain embodiments, user interface 100 may present one or more media titles to appear as a three-dimensional presentation expressing a notion of depth and/or weight of the graphical display elements.

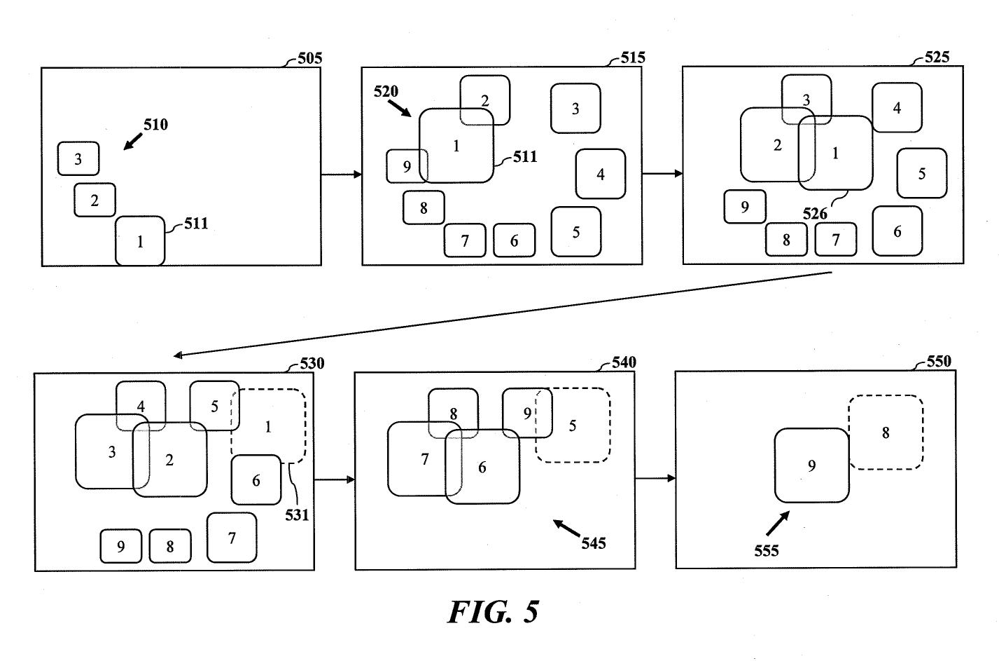

In certain embodiments, user interface 100 may include menu 140. Menu 140 may relate to a listing which a user may select to display one or more media titles and/or navigate the user interface. As depicted in FIG. 1, categories displayed by menu 140 may be selected by a user to view titles associated with the category. User selection of a menu category, such as a family category shown as 145, may result in display of particular media titles associated with the category. Further, the user interface may display category 145 with particular display attributes. User interface may also include spotlight shown as 150. As will be discussed in more detail below with reference to FIG. 5, media titles may alternatively be displayed based on alphabetical ordering. When arranged in a hierarchical structure related to alphabetical order, the user interface will display media titles associated with the letter selected.

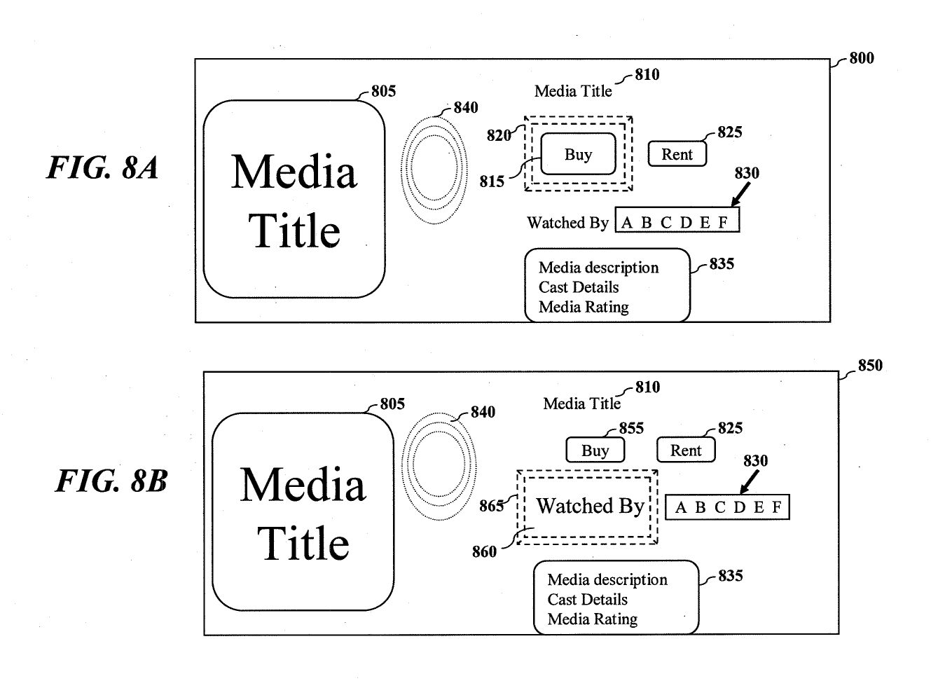

User interface 100 may be configured to transition the display of content relative to one or more formations, including a transition of graphical elements in a spiral formation to a detailed view of a media title as discussed in FIGS. 8A-8B. Although user interface 100 is described above with reference to media titles, it should be appreciated that the user interface may be employed for graphical display and/or presentation of different types of elements including but not limited to account management files, personnel files, data folders, calendar entries, contacts, etc.

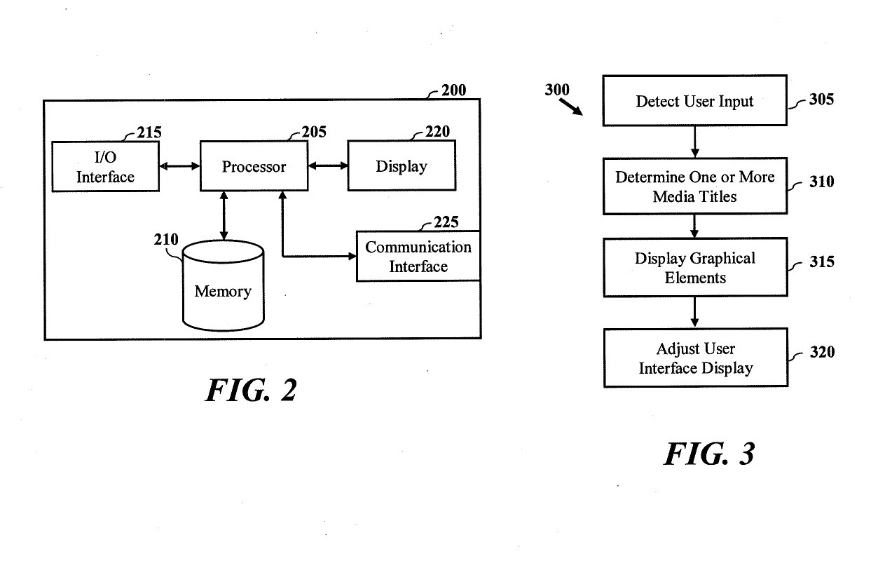

Referring now to FIG. 2, a simplified block diagram is depicted of a device according to one embodiment. In one embodiment, device 200 may be configured to provide a user interface to present a plurality of media titles. Device 200 may relate to a display device such as a television display for viewing media. It may also be appreciated that device 200 may relate to one or more devices configured to provide data to a display device such as, a set-top box, gaming console, media player (e.g., DVD, Blu-ray™, audio player, etc.), network based communication device, etc. In a further embodiment, device 200 may relate to portable electronic devices including media players, personal communication devices, etc. Device 200 may be configured to employ one or more of the processes described herein to present a plurality of media titles for a user.

As shown in FIG. 2, device 200 includes processor 205, memory 210, input/output (I/O) interface 215, display 220 and network communication interface 225. Processor 205 may be configured to control operation of device 200 based on one or more computer executable instructions stored in memory 210. Memory 210 may relate to one of RAM and ROM memories and may be configured to store one or more media files, content, and computer executable instructions for operation of device 200.

I/O interface 215 may include one or more buttons for user input, such as a numerical keypad, volume control, channel control, menu controls, pointing device, track ball, mode selection buttons, and playback functionality (e.g., play, stop, pause, forward, reverse, slow motion, etc). Buttons of I/O interface 215 may include hard and soft buttons, wherein functionality of the soft buttons may be based on one or more applications running on device 200. I/O interface 215 may be employed for one or more user commands, such as scrolling or selection of a graphical element. I/O interface 215 may additionally be configured to decode one or more remote control commands for navigating a user interface. In another embodiment, device 200 may include one or more optical drives, not shown in FIG. 2, which may be configured to detect and decode one or more media files stored on a disc (e.g., CD, DVD™, Blu-ray™, etc.). Display 220 may be employed to display a user interface. In certain embodiments, display 220 may relate to a touch screen display configured to detect one or more user selections of the display. Although depicted with a display, it may be appreciated that the display is optional in certain embodiments.

Communication interface 225 may be configured to allow for network based communications including but not limited to LAN, WAN, and Wi-Fi. Communication interface 225 may be configured to allow for one or more devices to communicate with device 200 via wired or wireless communication. Communication interface 225 may additionally include one or more ports for receiving data, including ports for removable memory.

Referring now to FIG. 3, a process for presenting media titles is depicted according to one embodiment. Process 300 may be performed by the device of FIG. 2 for presenting a plurality of media titles on a user interface (e.g., user interface 100). Process 300 may be initiated by detecting a user input associated with a user interface displayed by a device at block 305. User input commands may relate to control commands to change in position of the selected graphical display element. In one embodiment, a user input may relate to a directional command for navigating one or more of the displayed graphical elements of the user interface, such as a menu. A user input may relate a directional command for navigating the user interface, a user selection of a media title category, and/or a selection of a graphical element associated with a media title. The user interface may include a plurality of graphical elements arranged in a formation, wherein each element (e.g., media title 110) is associated with a media title or file and a focus state.

Process 300 may continue by determining one or more media titles for presentation in response to the user input at block 310. By way of example, when a user hovers on a menu item selects a category of the user interface, one or more media titles may be determined. User selection of a family category of the user interface may result in selecting one or more media titles associated with family programming. Media titles may be selected based on ratings generated for each media title relative to one or more attributes associated with the user. Ratings for media titles may be generated based on one or more of a genre of the media title, actor associated with the media title, subject matter of a media title, and category of the media title. Attributes associated with the user may relate to one or more of user viewing history, media titles associated with a user library, and user selections of the user interface.

At block 315, the device can display one or more graphical elements. For example, the device may display a first graphical element based on a selected media title, wherein the graphical element is assigned a focus state and associated with a first position of a spiral formation. The device may further display at least one additional graphical element based on one or more selected media titles. The additional graphical elements may be assigned a focus state and associated with a second and/or subsequent position of the spiral formation. Displaying a graphical element may relate to displaying an animation of the graphical elements following a spiral formation associated with a smooth transition between one or more focus states. In one embodiment, a spiral formation relates to a helical or spiral animation path for display of one or more graphical elements within the user interface. Displaying graphical elements associated with media titles with a spiral formation and a focus state may allow for the elements to appear as floating and/or suspended along the spiral formation within a user interface.

In one embodiment, graphical display elements (e.g., graphical display elements 105) may be displayed with a focus state relating to one or more of a glow accent, size adjustment and transparency of a graphical element associated with a media title. In an exemplary embodiment, one of four focus states may be employed. A disabled focus state may relate to display of the graphical element, wherein the graphical element is non-selectable. A normal focus state may include display with focus off. A focused state relates to display of the graphical element with focus on and including a glow accent. Display of a graphical element without focus (e.g., focus off) may relate to display of the graphical element as partially faded. Display of a media title with focus (e.g., focus on) may relate to display of a graphical element without visual fading. In one embodiment, the glow accent of the focused state may be associated with a color. The selected state relates to display of a graphical display element with focus on and a glow accent associated with a color different from that of the focused state glow accent. In one embodiment, the glow accent may relate to a blue accent, while the selected item may relate to a white accent.

Process 300 may continue by adjusting the display of the user interface at block 320, wherein a display position of each displayed graphical element is advanced relative to a previous display position of the spiral formation. Adjusting the display may relate to updating a display position of one or more graphical elements with respect to a spiral formation. Alternatively, adjusting may relate to displaying one or more graphical elements in a grid formation based on a user selection. As will be discussed below in more detail, adjusting the user interface may result in a change of one or more focus states.

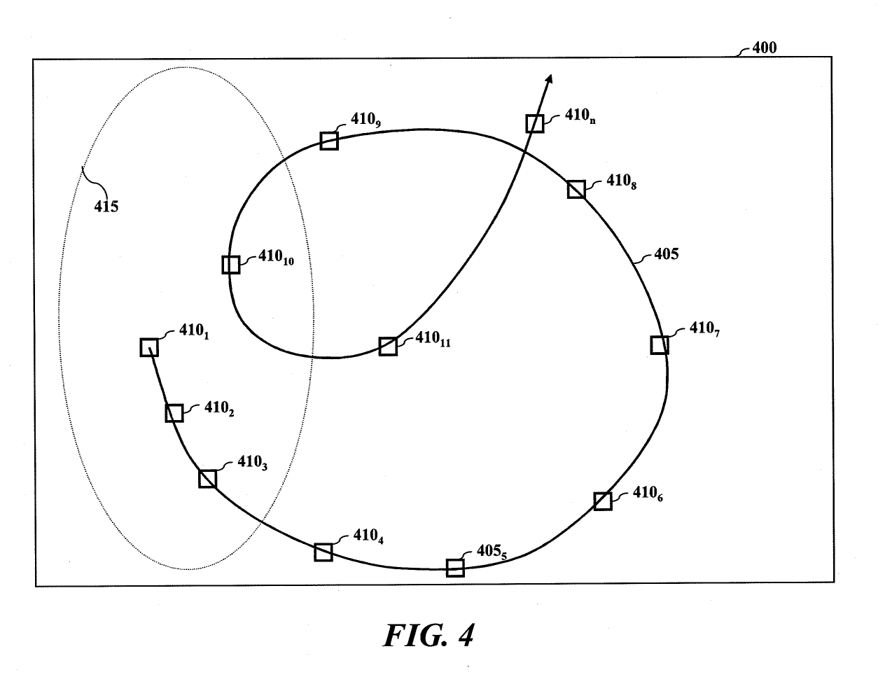

FIG. 4 depicts a graphical representation of a spiral formation for displaying graphical elements of a user interface. In one embodiment, a user interface window, shown as 400, may display graphical elements as an animation of media titles (e.g., media title 110), wherein the graphical elements are displayed as floating and/or suspended within at least a portion of user interface window 400. In one embodiment, presentation order of one or more media titles may be associated with a relevance, importance and/or rating determined for each media title. Display of the media titles may be performed by graduating one or more of a graphical elements shape, size, and transparency along a spiral formation. The spiral formation may relate to a helical path, shown as 405. Helical path 405 includes a plurality of markers, shown as 410₁₋ₙ, as an example of spacing of one or more media titles that may be displayed (e.g., first and second positions). Although a spiral path has been described with reference to helical path 405, it may be appreciated that other paths may be similarly employed. According to another embodiment, user interface 400 may additionally display a spotlight accent, shown as 415. Spotlight accent 415 may relate to one of a white or colored accent to improve the visual display of the user interface.

Referring now to FIG. 5, a graphical representation is depicted of presenting graphical display elements according to one or more embodiments. As discussed, the user interface may display one or more media titles. Display of media titles may include gradually presenting graphical elements associated with one or more media titles. The user interface may be configured to display a first graphical element and present the graphical element along a spiral formation (e.g., spiral path 405), wherein additional media elements are displayed as a graphical element is presented along the path. As depicted in block 505, graphical elements, shown as 510, may be displayed following display of a first graphical element 511. As further depicted in FIG. 5, graphical element 511 is displayed with increased size relative to graphical elements 510. Although not shown in block 505, graphical elements may be displayed with graduated transparency. As depicted in FIG. 5, graphical elements are numbered to indicate order of the elements for illustration purposes. Further, each of the graphical elements may be selected by a user. Selection of a graphical element may result in display a detailed description of the media title, as will be discussed in more detail below with reference to FIGS. 8A-8B.

Block 515 of FIG. 5 depicts a transition of graphical elements and the addition of graphical elements for presenting one or more media titles. As depicted in block 515, a media title may increase in size as the graphical elements follow a spiral formation (e.g., spiral path 405). Further, as shown by 520, a first graphical element may be displayed with a degree of transparency relative to other graphical elements. At block 525, the graphical elements may continue to be displayed along the spiral formation, wherein a graphical element may be centrally displayed, shown as block 526. It may also be appreciated that block 526 may be displayed to include one or more of a glow accent and spotlight treatment.

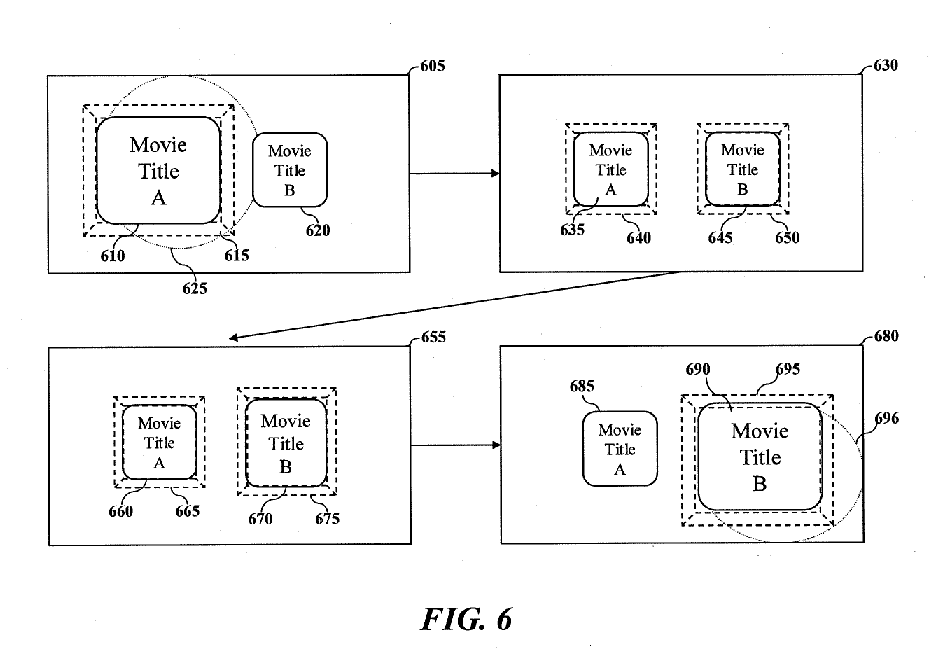

Referring now to block 530 of FIG. 5, the graphical elements may continue to be displayed in a spiral formation, wherein the first graphical element, shown as 531, is displayed as fading out as the graphical element nears the end of the spiral formation. At block 530, the presentation of graphical display elements continues wherein the number of blocks displayed is reduced. In certain embodiments, graphical display of the media titles in a spiral formation may be based on user selection of a menu. Alternatively, display of the media tiles in a spiral formation may be provided to provide a user with a preview of media titles associated with a category. Accordingly, display of the media titles, as shown by 545, may reduce the number of graphical elements displayed. At block 550, the last graphical element to be displayed in the spiral formation is centrally displayed, shown as 555. Following display of the graphical elements, the presentation may be repeated. Alternatively, the user interface may display one or more titles in one of a grid formation and detail view following the display in the spiral formation. Display of graphical elements as depicted in FIG. 5 may further include one or more focus transitions as discussed in more detail below with reference to FIG. 6.

Referring now to FIG. 6, a graphical representation of adjusting a display is depicted according to one or more embodiments. According to one embodiment, display of graphical elements may include a focus state to indicate that a particular graphical display element is selected. Based on the selected focus state, the user may select a particular media file or data associated with the graphical display element. The selected focus state may further be employed by a user to select one or more of the graphical display elements and for navigating a plurality of graphical display elements. According to one embodiment, a user interface may employ a focus transition when the selected focus state transitions to another graphical display element.

FIG. 6 depicts a focus transition from a first graphical display element to a second graphical display element. The user interface, shown in block 605, includes first graphical display element 610 and second graphical display element 620. Graphical element 610 is depicted in a selected state, wherein display of the element includes a glow accent shown as 615. Graphical display element 620 is depicted as in a normal state, with focus off. Display of graphical display element 610 may further be associated with spotlight effect shown as 625. The spotlight effect may relate to backlighting of the background associated with the display element, wherein the element appears to include a glow effect that radiates outward. In one embodiment, spotlight effect 625 may be provided to assist a user in identifying a selected item and smooth a transition between changes in focus states.

The focus transition may be initiated at block 630. At block 630 the previously selected graphical display element, first element 635, fades to a focus state having glow accent 640. In addition, the second element 645 now includes glow accent 650. Glow accents 640 and 650 may be associated with one of a same color and different color. Alternatively, glow accents 640 and 650 may be different colors than the glow accent 615.

The focus transition may continue as shown in block 655. At block 655 the first graphical display element 660 includes glow accent 665 while second graphical display element 670 increases in size and includes glow accent 675 relative to the first graphical display of element 660. Second graphical display element 670 may be increased in size to emphasize the selected focus state. The transition completes in block 680 wherein the first graphical display element is depicted in a normal state, shown as 685, and second graphical display element 690 includes a glow accent shown as 695 and spotlight 696. The focus transition of FIG. 6 may be performed to provide a visual sense that the selection is moving between items and facilitate user viewing enjoyment of a selection area.

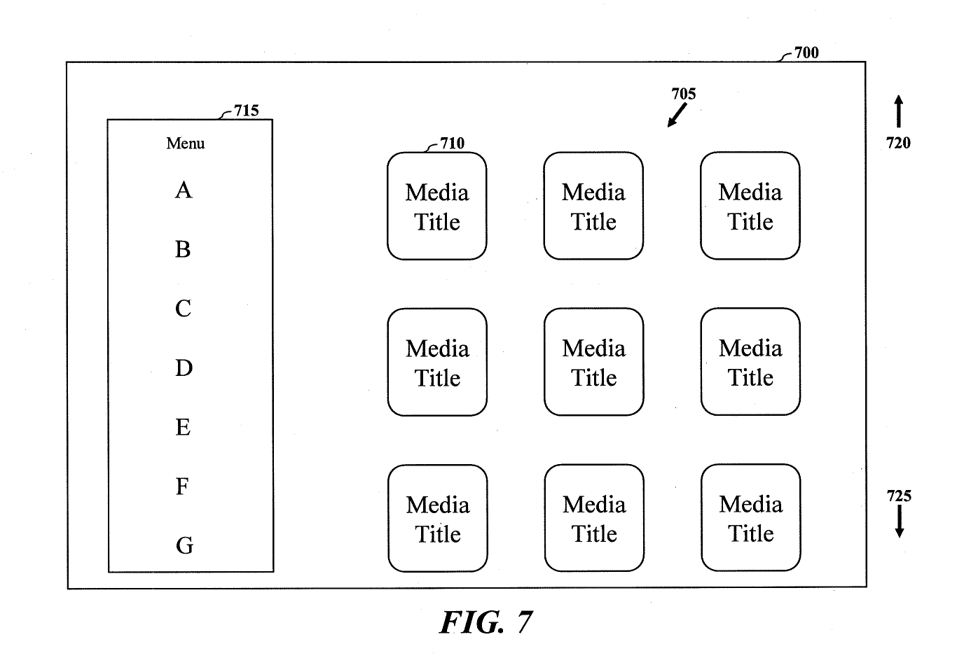

FIG. 7 depicts a graphical representation of a user interface according to one embodiment. As depicted, user interface 700 includes a plurality of graphical elements shown as 705. In particular, user interface 700 may display one or more graphical display elements to present a plurality of media titles. Graphical elements 705 may relate to a subset of media titles which may be presented to a user. It should also be appreciated that a greater or smaller number of media titles may be displayed by the user interface at a time. Media title 710, for example, may relate to a graphical image and/or text associated with a media file. By way of further example, when media presented by user interface 700 relates to movie titles, media title 710 may be displayed as cover art for a particular movie title. Media titles displayed by user interface 700 may relate to one or more of movie titles, video content, broadcast media (e.g., television series) audio files, etc.

In certain embodiments, user interface 700 may include menu 715. Menu 715 may relate to a listing that a user may select to display one or more media titles. For example, as depicted in FIG. 7, letters displayed by menu 715 may be selected by a user to view titles based on alphabetical order. When arranged in a hierarchical structure related to alphabetical order, the user interface will display media titles associated with the letter selected. As will be discussed in more detail below with reference to FIG. 5, media titles may alternatively be displayed based on a category.

According to one embodiment, media titles 705 are depicted in a formation associated with a grid unit. Media titles may be arranged in a hierarchical arrangement, wherein a user may scroll, as shown by direction arrows 720 and 725. Arrangement of media titles in a hierarchical arrangement may be based on categorizations of featured or recommended content and then based on menu categorizations. In that fashion, media titles 705 may relate to a subset of media titles which may be presented to a user. By displaying a subset of the media titles available, a user may be presented with a manageable set of titles.

According to another embodiment, a user interface may provide detailed information and one or more functions of a selected media title when selected by a user. Further, the user interface may employ a focus transition of graphical display elements to aid in user navigation. Referring now to FIGS. 8A-8B, graphical representations of user interface focus states are depicted according to one or more embodiments. Referring first to FIG. 8A, user interface 800 includes a graphical display of a media title shown as 805. Graphical display 805 may relate to cover art of the media title and/or a graphical tile includes text or graphics associated with the media title. User interface 800 may further display text associated with a media title shown as 810. User interface 800 may further include one or more graphical elements which may be selected and employed by a user to perform functions associated with media title 805.

Graphical display element 815 relates to a buy or purchase button which may be selected by the user to purchase media associated with title 805. Graphical display element 815 is depicted with a selected focus state to include glow accent shown by 820. Graphical display element 825 relates to a selection button which may be selected to rent media title 805. User interface 800 may further include a plurality of icons, shown by 830, wherein each icon may be selected as a source of the media content. User interface 800 further includes media data shown as 835 which may be selected by a user to obtain further information and details of media title 805. It may further be appreciated that a spotlight may be applied in FIGS. 8A-8B, depicted as 840.

Referring now to FIG. 8B, a graphical representation is depicted of the user interface of FIG. 8A, following a focus transition. User interface 850 includes buy button 855 presenting a normal focus state. Based on a user selection of watched by, the user interface now highlights watched by button 860, wherein the button is in a selected state including glow accent 665.

While this disclosure has been particularly shown and described with references to exemplary embodiments thereof, it will be understood by those skilled in the art that various changes in form and details may be made therein without departing from the scope of the disclosure encompassed by the appended claims.

What is claimed is:

1. A method for displaying a user interface to present a plurality of media titles, the method comprising the acts of:
detecting a user input associated with a displayed user interface;
determining, by a device, one or more media titles for presentation in response to the user input, wherein media titles are selected based on ratings generated for each media title relative to one or more attributes associated with the user;
displaying a first a graphical element based on a selected media title, wherein the first graphical element is assigned a focus state and associated with a position of a spiral formation;
displaying at least one additional graphical element based on one or more selected media titles, wherein the at least one additional graphical element is assigned a focus state and associated with a position of the spiral formation; and
adjusting the display of the user interface, wherein a display position of each displayed graphical element is advanced relative to a previous display position of the spiral formation.

2. The method of claim 1, wherein the user input relates to at least one of a directional command for navigating the user interface, a user selection of a media title category, and selection of a graphical element associated with a media title.

3. The method of claim 1, wherein ratings for media titles are generated based on one or more of a genre of the media title, actor associated with the media title, subject matter of a media title, and category of the media title.

4. The method of claim 1, wherein attributes associated with the user relate to one or more of user viewing history, media titles associated with a user library, and user selections of the user interface.

5. The method of claim 1, wherein order of display for selected media titles is based on the rating determined for each selected media filed, wherein highest rated media titles are presented to the user first.

6. The method of claim 1, wherein the spiral formation relates to a helical animation path for display of one or more graphical elements within the user interface.

7. The method of claim 1, wherein each graphical element is displayed to appear as floating along the spiral formation within the user interface.

8. The method of claim 1, wherein a focus state relates to one or more of a glow accent, size adjustment and transparency of a graphical element associated with a media title.

9. The method of claim 1, wherein adjusting the display further comprises displaying one or more graphical elements in a grid formation based on a user selection.

10. A computer program product stored on computer readable medium including computer executable code for displaying a user interface to present a plurality of media titles, the computer program product comprising:
computer readable code to detect a user input associated with a displayed user interface;
computer readable code to determine one or more media titles for presentation in response to the user input, wherein media titles are selected based on ratings generated for each media title relative to one or more attributes associated with the user;
computer readable code to display a first a graphical element based on a selected media title, wherein the first graphical element is assigned a focus state and associated with a position of a spiral formation;
computer readable code to display at least one additional graphical element based on one or more selected media titles, wherein the at least one additional graphical element is assigned a focus state and associated with a position of the spiral formation; and
computer readable code to adjust the display of the user interface, wherein a display position of each displayed graphical element is advanced relative to a previous display position of the spiral formation.

11. The computer program product of claim 10, wherein the user input relates to a directional command for navigating one or more of the displayed graphical elements of the user interface.

12. The computer program product of claim 10, wherein the spiral formation relates to a helical animation path for display of one or more graphical elements within the user interface.

13. The computer program product of claim 10, wherein each graphical element is displayed to appear as floating along a spiral formation within the user interface.

14. The computer program product of claim 10, wherein a focus state relates to one or more of a glow accent, size adjustment and transparency of a graphical element associated with a media title.

15. The computer program product of claim 10, wherein computer readable code to display a graphical element relates to displaying an animation of the graphical element following a spiral formation associated with a smooth transition between one or more focus states.

16. The computer program product of claim 10, further comprising computer readable code to update a display position of a graphical element with respect to a spiral formation.

17. The computer program product of claim 10, further comprising computer readable code to display one or more graphical elements in a grid formation based on a user selection.

18. A device, comprising:
a display;
a memory; and
a processor coupled to the display, and memory, the processor configured to:
detect a user input associated with a displayed user interface;
determine one or more media titles for presentation in response to the user input, wherein media titles are selected based on ratings generated for each media title relative to one or more attributes associated with the user;
control display of a first a graphical element based on a selected media title, wherein the first graphical element is assigned a focus state and associated with a position of a spiral formation;
control display of at least one additional graphical element based on one or more selected media titles, wherein the at least one additional graphical element is assigned a focus state and associated with a position of the spiral formation; and
adjust the display of the user interface, wherein a display position of each displayed graphical element is advanced relative to a previous display position of the spiral formation.

19. A method for displaying a user interface to present a plurality of media titles, the method comprising the acts of:
determining, by a device, one or more media titles for presentation, wherein media titles are selected based on ratings generated for each media title relative to one or more attributes associated with a user;
displaying a first a graphical element based on a selected media title, wherein the graphical element is assigned a focus state;
displaying at least one additional graphical element based on one or more selected media titles, wherein the at least one additional graphical element is assigned a focus state; and
adjusting the display of the user interface, wherein a display position of each displayed graphical element is advanced relative to a display formation.
